(19) United States
(12) Patent Application Publication
(10) Pub. No.: US 2026/0267940 A1
(43) Pub. Date: Sep. 10, 2026

(54) PERFORMANCE ANOMALY DETECTION IN STORAGE SYSTEMS USING AUTOENCODER WITH HIERARCHICAL MULTI-FREQUENCY DECODING

(71) Applicant: Dell Products L.P., Round Rock, TX (US)

(72) Inventors: Karthik Hubli, Northborough, MA (US); Siva Rama Krishna Kottapalli, Dracut, MA (US); Davidson Devasigamony, Boxborough, MA (US)

(21) Appl. No.: 19/074,601

(22) Filed: Mar. 10, 2025

(51) Int. Cl. G06F 3/06

(52) U.S. Cl. CPC G06F 18/2433; G06F 11/3447; G06N 3/0455; G06F 11/3476

(57) ABSTRACT

Performance anomaly detection in storage systems (e.g., using a computerized tool), is enabled. For example, a system can comprise at least one processor and at least one memory that stores executable instructions that, when executed by the processor, facilitate performance of operations. Some corresponding operations can comprise, based on defined segments segmented from storage system performance data comprising at least two different time frequencies and using a performance data encoder-decoder model, generating reconstructed time series data, wherein the performance data encoder-decoder model was trained based on normalized training data and using mean squared error and dynamic time warping, and wherein the normalized training data was generated from the defined segments that were normalized and aligned, and in response to a determination that a reconstruction value of reconstruction errors exceeds a defined threshold, generating an output indicative of the reconstruction value being determined to be an anomaly.

### BACKGROUND

Artificial intelligence (AI) and machine learning (ML) can be utilized, for instance, to automate IT operations, improve system performance, and optimize resource utilization. Performance data for proactive information technology (IT) monitoring and automation is often captured at five-minute, hourly, or daily intervals.

The above-described background relating to IT monitoring and automation is merely intended to provide a contextual overview of some current issues and is not intended to be exhaustive. Other contextual information may become further apparent upon review of the following detailed description.

### BRIEF DESCRIPTION OF DRAWINGS

FIG. 1 is a block diagram of an example system in accordance with one or more example embodiments described herein.

FIG. 2 is a block diagram of example computer executable components in accordance with one or more example embodiments described herein.

FIG. 3 is a diagram of sample data at different frequencies (resolutions) in accordance with one or more example embodiments described herein.

FIG. 4 is diagram depicting autoencoding and hierarchical decoding in accordance with one or more example embodiments described herein.

FIGS. 5A-5C are diagrams of example input test data, segmented test data, and normalized segmented test data in accordance with one or more example embodiments described herein.

FIG. 6 is a diagram of example reconstruction in accordance with one or more example embodiments described herein.

FIG. 7 is a chart of an example reconstruction error distribution with anomalies in accordance with one or more example embodiments described herein.

FIG. 8 is a block flow diagram for a process associated with performance anomaly detection in storage systems using autoencoder with hierarchical multi-frequency decoding in accordance with one or more example embodiments described herein.

FIG. 9 is a block flow diagram for a process associated with performance anomaly detection in storage systems using autoencoder with hierarchical multi-frequency decoding in accordance with one or more example embodiments described herein.

FIG. 10 is a block flow diagram for a process associated with performance anomaly detection in storage systems using autoencoder with hierarchical multi-frequency decoding in accordance with one or more example embodiments described herein.

FIG. 11 is an example, non-limiting computing environment in which one or more embodiments described herein can be implemented.

FIG. 12 is an example, non-limiting networking environment in which one or more embodiments described herein can be implemented.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

With respect to IT monitoring and automation solutions, a data aggregation (e.g., data processing) layer may utilize only five-minute, one-hour, or daily data points for performance anomaly detection. Because of the on device aggregation for the above mentioned data points, short lived anomalies (e.g., which may last fewer than five minutes) can be completely missed during a performance anomaly detection process. For example, for systems which capture high-frequency performance data at five-second or twenty-second intervals, conventional systems may only store aggregated five-minute averages in the cloud. This practice results in the loss of potentially valuable anomalies that are crucial for proactive system performance management.

In this regard, performance anomaly detection in storage systems can be improved in various ways, and various embodiments are described herein to this end and/or other ends.

According to an example embodiment, a system can comprise at least one processor, and at least one memory that stores executable instructions that, when executed by the at least one processor, facilitate performance of operations, comprising based on defined segments segmented from storage system performance data comprising at least two different time frequencies and using a performance data encoder-decoder model, generating reconstructed time series data, wherein the performance data encoder-decoder model was trained based on normalized training data and using mean squared error and dynamic time warping, and wherein the normalized training data was generated from the defined segments that were normalized and aligned, based on the reconstructed time series data and the defined segments, determining reconstruction errors applicable to the reconstructed time series data, fitting a normal distribution to the reconstruction errors, based on the normal distribution, determining a defined threshold for anomaly scores applicable to the reconstruction errors, and in response to a determination that a reconstruction value of the reconstruction errors exceeds the defined threshold, generating an output indicative of the reconstruction value being determined to be an anomaly.

In one or more example embodiments, generating the reconstructed time series data can comprise generating the reconstructed time series data using a defined hierarchical decoding process.

In one or more example embodiments, the above operations can further comprise, based on a quantity of frequencies of the at least two different time frequencies, determining a quantity of encoding layers for use with the performance data encoder-decoder model.

In one or more example embodiments, the above operations can further comprise determining a confidence level applicable to the reconstruction errors, wherein the defined threshold is further determined based on the confidence level.

In one or more example embodiments, the storage system performance data can comprise at least one of a latency, a bandwidth, or a file size applicable to a storage system.

In one or more example embodiments, the performance data encoder-decoder model can comprise a long short-term memory model.

In one or more example embodiments, the above operations can further comprise, in response to determining the reconstruction errors, deleting the storage system performance data.

In one or more example embodiments, the normalized and aligned defined segments can be generated based on duplicates of first data points of first defined segments of the defined segments, and, as a result of the duplicates being generated, first data points of the first defined segments can be equal in quantity to second data points of second defined segments of the defined segments.

In one or more example embodiments, the performance data encoder-decoder model can be trained based on weights determined to be applicable to training of the performance data encoder-decoder model.

In one or more example embodiments, the storage system performance data can comprise at least one of one-minute aggregated time series data aggregated every minute, five-minute aggregated time series data aggregated every five minutes, hourly aggregated time series data aggregated every hour, or daily aggregated time series data aggregated every day.

In one or more example embodiments, the storage system performance data can be representative of performance data of a defined group of devices.

In one or more example embodiments, the reconstructed time series data can comprise an aggregate of the at least two different time frequencies.

In another example embodiment, a non-transitory machine-readable medium can comprise executable instructions that, when executed by at least one processor, facilitate performance of operations, comprising, based on defined segments segmented from storage system performance data comprising a group of different time frequencies and using a performance data encoder-decoder model, generating reconstructed time series data, wherein the performance data encoder-decoder model was trained based on normalized training data and using mean squared error and dynamic time warping, and wherein the normalized training data was generated from the defined segments that were normalized, based on the reconstructed time series data and the defined segments, determining reconstruction errors applicable to the reconstructed time series data, determining a normal distribution that fits the reconstruction errors, based on the normal distribution, determining a defined threshold for anomaly scores applicable to the reconstruction errors, and in response to a determination that a reconstruction value of the reconstruction errors exceeds the defined threshold, generating an output indicative of the reconstruction value being determined to be an anomaly.

In one or more example embodiments, generating the reconstructed time series data can comprise generating the reconstructed time series data using a defined hierarchical decoding process.

In one or more example embodiments, the above operations can further comprise, based on a quantity of frequencies of the group of different time frequencies, determining a quantity of encoding layers to be utilized with the performance data encoder-decoder model.

In one or more example embodiments, the above operations can further comprise determining a confidence level applicable to the reconstruction errors, wherein the defined threshold is further determined based on the confidence level.

In one or more example embodiments, the storage system performance data can comprise at least one of a latency, a bandwidth, or a file size applicable to a storage system.

In yet another example embodiment, a method can comprise, based on defined segments segmented from storage system performance data comprising a group of different time frequencies and using a performance data encoder-decoder model, generating, by a system comprising at least one processor, reconstructed time series data, wherein the performance data encoder-decoder model was trained based on normalized training data and using mean squared error and dynamic time warping, and wherein the normalized training data was generated from the defined segments that were normalized, based on the reconstructed time series data and the defined segments, determining, by the system, reconstruction errors applicable to the reconstructed time series data, fitting, by the system, a normal distribution to the reconstruction errors, based on the normal distribution, determining, by the system, a defined threshold for anomaly scores applicable to the reconstruction errors, and in response to a determination that a reconstruction value of the reconstruction errors exceeds the defined threshold, generating, by the system, an output indicative of the reconstruction value being determined to be an anomaly.

In one or more example embodiments, the above method can further comprise, in response to determining the reconstruction errors, removing, by the system, the storage system performance data.

In one or more example embodiments, the reconstructed time series data can comprise an aggregate of the group of different time frequencies.

Embodiments herein enable use of high-frequency data, without saving it with higher corresponding storage costs, and at shorter retention time intervals. Storage of high-frequency data can result in the generation of substantial data volumes, necessitating extensive storage capacity and computational power and leading to increased costs and slower processing times. Embodiments herein can generalize the anomalies based on both micro and macro level details. Relying solely on one-hour frequency data aggregates short-term fluctuations, smoothing out significant variations and potentially obscuring critical anomalies that occur on smaller timescales. This averaging process can lead to missed detections of important events. For example, if a significant anomaly occurs just after an hourly data point is recorded, it may not be recognized until the next hour, thus delaying the response time, and potentially exacerbating the issue. Hourly data offers a high-level overview but lacks the fine-grained detail necessary for in-depth analysis, thus hindering the ability to diagnose the root cause of anomalies and understand the nuanced behavior of a corresponding system.

As noted above, utilization of high-frequency data can lead to a large volume of data points accumulating rapidly. For example, capturing data at five-second intervals results in twelve data points per minute, 720 data points per hour, and over 17,000 data points per day. And these quantities are for single systems and for single metric. In this regard, IT monitoring and automation systems can capture data of nearly 400,000 systems at different object levels, and each object can contain anywhere greater than thirty different metrics, in some instances. This substantial amount of data requires significant storage capacity. However, embodiments herein utilize a structured approach in which data is compressed (e.g., via a system herein) into latent representations through a series of encoders (e.g., via a performance data encoder-decoder model). These latent representations are significantly smaller than the original high-frequency data, and thus embodiments herein enable a reduction of both storage and computational requirements.

Anomaly detection models developed using high frequency data often contain short-lived spikes and fluctuations, which are generally not indicative of true system anomalies but rather noise. This can result in a high rate of false positives, in which normal variations are misclassified as anomalies, thus leading to unnecessary alerts and potential fatigue in the monitoring process. However, embodiments herein capture both macro (e.g., low-frequency) and micro (e.g., high-frequency) temporal patterns through a hierarchical approach. This enables a trained model (e.g., a performance data encoder-decoder model) to distinguish between short-lived noise and sustained anomalies, for instance, by integrating (e.g., via a system enabled herein) information across different frequencies.

While high-frequency data captures minute details, it lacks the broader temporal context. This narrow view may prevent the identification of long-term trends and patterns that contribute to more accurate and meaningful anomaly detection. However, in various embodiments described herein, combining data from various frequencies into a single model output provides a holistic understanding, thus balancing the need for detail and context.

Aggregating data into one-hour intervals or one-day intervals can smooth out significant short-term fluctuations. However, this averaging process can obscure critical anomalies that occur on a smaller timescale, thus resulting in missed detections of important events. However, in various embodiments described herein, by integrating insights from both high and low-frequency data, a corresponding model (e.g., a performance data encoder-decoder model) can enable a nuanced understanding of system behavior, thus facilitating more accurate and informative anomaly detections.

With lower frequency data, there is an inherent delay in detecting anomalies. For instance, if a significant anomaly occurs just after an hourly data point is recorded, it may not be recognized until the next hour, thus delaying the response time, and potentially exacerbating the issue. However, in various embodiments described herein, the model and system's ability to handle data at various granularities means that the model does not rely solely on delayed, aggregated intervals.

Anomalies that are subtle or occur quickly may not be captured in hourly data aggregations. These micro anomalies, which may indicate early signs of larger issues, can be critical for proactive maintenance and early intervention. However, micro anomalies that could indicate early signs of larger issues are captured through short-length decoders in various embodiments enabled herein.

Various embodiments described herein utilize an autoencoder (e.g., via a system herein) with hierarchical decoding, which effectively addresses the limitations of using both high frequency and low frequency data for detection of anomalies in performance data. Embodiments herein utilize a structured approach in which data is compressed into latent representations through a series of encoders (e.g., via a system described herein). These representations are significantly smaller than the original high-frequency data, thus reducing both storage and computation requirements. In this regard, the model captures both macro and micro temporal patterns through a hierarchical approach. Embodiments described herein can be utilized, for instance, when latency or another performance metric (e.g., bandwidth, file size, or another suitable metric) is abnormally high or abnormally low for a given period of time.

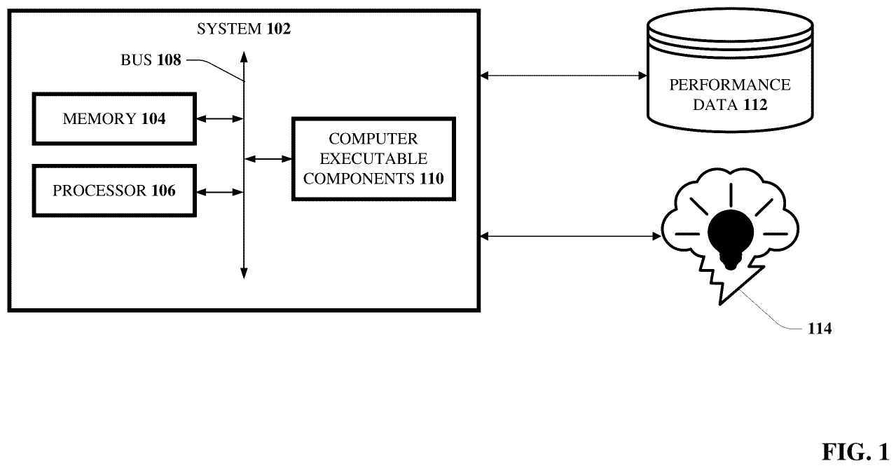

Turning now to FIG. 1, there is illustrated an example, non-limiting system 102 in accordance with one or more example embodiments herein. System 102 can comprise a computerized tool, which can be configured to perform various operations relating to performance anomaly detection in storage systems using autoencoder with hierarchical multi-frequency decoding. The system 102 can comprise one or more of a variety of components, such as memory 104, processor 106, bus 108, and/or computer executable components 110. In various embodiments, one or more of the memory 104, processor 106, bus 108, and/or computer executable components 110 can be communicatively or operably coupled (e.g., over a bus or wireless network) to one another to perform one or more functions of the system 102. In various example embodiments, the system 102 can comprise and/or be communicatively coupled to performance data 112 (e.g., contained in a corresponding data store) and/or performance data encoder-decoder model 114.

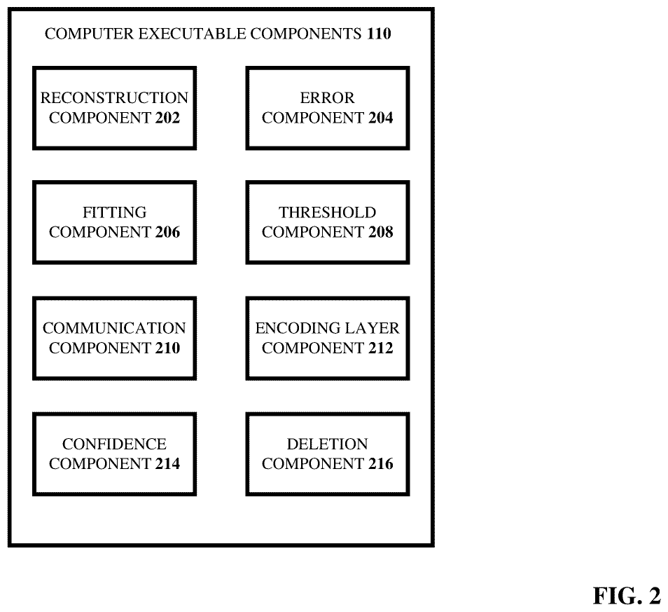

FIG. 2 illustrates a block diagram of example, non-limiting computer executable components 110 that can facilitate performance anomaly detection in storage systems using autoencoder with hierarchical multi-frequency decoding in accordance with one or more embodiments described herein. Repetitive description of like elements employed in other embodiments described herein is omitted for sake of brevity. As shown in FIG. 2, the one or more computer executable components 110 can comprise reconstruction component 202, error component 204, fitting component 206, threshold component 208, communication component 210, encoding layer component 212, confidence component 214, and/or deletion component 216.

In various example embodiments, the reconstruction component 202 can, based on defined segments segmented from storage system performance data (e.g., performance data 112) comprising at least two different time frequencies and using a performance data encoder-decoder model (e.g., performance data encoder-decoder model), generate reconstructed time series data. In one or more example embodiments, as alluded to above, the storage system performance data 112 can comprise at least one of one-minute aggregated time series data aggregated every minute, five-minute aggregated time series data aggregated every five minutes, hourly aggregated time series data aggregated every hour, or daily aggregated time series data aggregated every day, though any other suitable time series data can be utilized by the system 102. In one or more example embodiments, the storage system performance data 112 can be representative of performance data of a defined group of devices. In this regard the performance data 112 can be representative of a singular device or a group of devices (e.g., more than one device). In one or more example embodiments, the storage system performance data 112 can comprise at least one of a latency, a bandwidth, a file size applicable to a storage system or device, or other suitable system performance data. In various example embodiments herein, the reconstructed time series data can comprise an aggregate of the at least two different time frequencies.

In one or more example embodiments, the performance data encoder-decoder model 114 can comprise a long short-term memory model. In this regard, the performance data encoder-decoder model 114 can comprise a recurrent neural network (RNN). In one or more example embodiments, the performance data encoder-decoder model 114 can be trained based on weights determined (e.g., via the system 102) to be applicable to training of the performance data encoder-decoder model 114. In this regard, the performance data encoder-decoder model 114 can be trained, for instance, using a defined weighted loss function, in which different parts of the time series or feature dimensions are emphasized according to their determined (e.g., learned) or defined importance.

In this regard, the performance data encoder-decoder model 114 can be trained based on normalized training data and use mean squared error (MSE) and/or dynamic time warping/wrapping (DTW). Further in this regard, the normalized training data can be generated from the defined segments that were normalized and aligned. In one or more embodiments, the training data can be retrieved from different machines (e.g., devices) comprising different measurement scales, and thus data normalization herein can bound such training data for use by the performance data encoder-decoder model 114 (e.g., a neural network). In order to normalize such data herein, the system 102 can utilize one or more defined data normalization processes. In this regard, in order to normalize data herein, the system 102 can perform minimum-maximum scaling, z-score normalization, log transformation, differencing, mean normalization, seasonal normalization, machine-learning or neural network based data normalization approaches, and/or other suitable data normalization processes. In one or more example embodiments, the normalized and aligned defined segments can be generated (e.g., via the system 102) based on duplicates of first data points of first defined segments of the defined segments. In this regard, as a result of the duplicates being generated, first data points of the first defined segments can be equal in quantity to second data points of second defined segments of the defined segments. For instance, as a result of the normalization and alignment, a one-minute time series and a five-minute time series can comprise an equal quantity of data points.

In one or more example embodiments, the reconstruction component 202 can generate the above reconstructed time series data using a defined hierarchical decoding process. In this regard, the reconstruction component 202 can break the reconstruction process down into levels of abstraction, for instance, moving from coarse to fine-grained representations. The foregoing can, for instance, help improve the quality of time series reconstructions (e.g., via the reconstruction component 202), especially in situations in which data is missing, corrupted, or compressed.

In various example embodiments, the error component 204 can, based on the reconstructed time series data and the defined segments, determine reconstruction errors applicable to the reconstructed time series data. In one or more example embodiments, the error component 204 can calculate reconstruction error, for instance, based on MSE and/or DTW. In this regard, the error component 204 can determine the reconstruction errors (e.g., using MSE) using the following equation:

$$M S {E}_{k} = {\sum }_{i = 1}^{n} {( {x}_{i} - {\hat{x}}_{i} )}^{2} \qquad Equation ( 1 )$$

where xᵢ is the original input, \hat{x}ᵢ is the reconstructed output, and n is the number of data points. k is for each frequency and can be from 1 to l.

In various example embodiments, the fitting component 206 can fit a normal distribution to the reconstruction errors. In order to fit a normal distribution to the reconstruction errors, the system 102 (e.g., via the fitting component 206) can calculate the mean and standard deviation of the reconstruction error (e.g., for one frequency), for instance, using the following equations:

$$μ = \frac{1}{n} {\sum }_{i = 1}^{n} {e}_{i} \qquad Equation ( 2 )$$

$$σ = \sqrt{\frac{1}{n} {\sum }_{i = 1}^{n} {( {e}_{i} - μ )}^{2}} \qquad Equation ( 3 )$$

In one or more example embodiments, the fitting component 206 can estimate normal distribution parameters for the reconstructed errors, and the threshold can be determined (e.g., via the threshold component 208) based on a specified confidence level. In this regard, the threshold component 208 can, based on the normal distribution, determine a defined threshold for anomaly scores applicable to the reconstruction errors. Further in this regard, reconstruction errors outside of this threshold can be flagged (e.g., via the system 102) as an anomaly. The confidence level can be determined (e.g., via the fitting component 206 and/or the threshold component 208) such that certain percentage of normal data is expected to fall below the threshold. Using an inverse cumulative distribution function, the threshold component 208 can determine the threshold (e.g., for an example 0.99 confidence level).

$$confidence level ( α ) = 0.99 \qquad Equation ( 4 )$$

$${z}_{α} = norm . inverse\_cdf ( α ) \qquad Equation ( 5 )$$

$$threshold ( {e}_{α} ) = μ + {z}_{α} * σ \qquad Equation ( 6 )$$

It is noted that a confidence level of 0.99 is a nonlimiting example, and other suitable confidence levels can be utilized in various embodiments described herein. In various example embodiments, the confidence component 214 can determine a confidence level applicable to the reconstruction errors. In this regard, the defined threshold can be further determined based on the confidence level. In some example embodiments, the confidence level can comprise a predefined confidence level. In further embodiments, the confidence component 214 can determine the confidence level, for instance, based on defined system or operational requirements, or other suitable factors. Additionally, or alternatively, the confidence component 214 can determine the confidence level using machine learning trained based on past confidence levels and past reconstruction errors, other than the instant reconstruction errors.

In various example embodiments, the communication component 210 can, in response to a determination that a reconstruction value of the reconstruction errors exceeds the defined threshold, generate an output indicative of the reconstruction value being determined to be an anomaly. For example, the communication component 210 can generate a corresponding log entry, an alert or notification, a visual representation, an application programming interface (API) response, or another suitable output. In further embodiments, the communication component 210 can send a corresponding message to another device communicatively coupled to the system 102.

In various example embodiments, the encoding layer component 212 can, based on a quantity of frequencies of the at least two different time frequencies, determine a quantity of encoding layers for use with the performance data encoder-decoder model (e.g., performance data encoder-decoder model 114). In some embodiments, the encoding layer component 212 can determine the quantity of encoding layers based on a defined relationship between frequencies and encoding layers. Additionally, or alternatively, the encoding layer component 212 can determine the quantity of encoding layers using machine learning trained based on previous encoding layers and previous time frequencies (e.g., other than the instant encoding layers and instant time frequencies).

In various example embodiments, the deletion component 216 can, in response to determining the reconstruction errors, delete (e.g., remove) the storage system performance data 112. The foregoing is enabled via the system 102, for instance, due to the compression (e.g., via the system 102) into latent representations through a series of encoders (e.g., via the performance data encoder-decoder model 114). These latent representations are significantly smaller than the original data, and thus the system 102 enables a reduction of both storage and computational requirements.

Various example embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or machine learning components herein can comprise artificial intelligence component(s) which can employ an AI model and/or ML or an ML model that can learn to perform the above or below described functions (e.g., via training using historical training data and/or feedback data).

In some embodiments, system 102 can comprise an AI and/or ML model that can be trained (e.g., via supervised and/or unsupervised techniques) to perform the above or below-described functions using historical training data comprising various context conditions that correspond to various augmented network optimization operations. In this example, such an AI and/or ML model can further learn (e.g., via supervised and/or unsupervised techniques) to perform the above or below-described functions using training data comprising feedback data, where such feedback data can be collected and/or stored (e.g., in memory) by the system 102. In this example, such feedback data can comprise the various instructions described above/below that can be input, for instance, to a system herein, over time in response to observed/stored context-based information.

The system 102 can initiate an operation(s) associated with a based on a defined level of confidence determined using information (e.g., feedback data). For example, based on learning to perform such functions described above using feedback data, performance information, and/or past performance information herein, the system 102 herein can initiate an operation associated with determining various thresholds herein (e.g., a motion pattern thresholds, input pattern thresholds, similarity thresholds, authentication signal thresholds, audio frequency thresholds, or other suitable thresholds).

In an example embodiment, the system 102 can perform a utility-based analysis that factors cost of initiating the above-described operations versus benefit. In this embodiment, the system 102 can use one or more additional context conditions to determine various thresholds herein.

To facilitate the above-described functions, the system 102 herein can perform classifications, correlations, inferences, and/or expressions associated with principles of artificial intelligence. For instance, the system 102 can employ an automatic classification system and/or an automatic classification. In one example, the system 102 can employ a probabilistic and/or statistical-based analysis (e.g., factoring into the analysis utilities and costs) to learn and/or generate inferences. The system 102 can employ any suitable machine-learning based techniques, statistical-based techniques, and/or probabilistic-based techniques. For example, the system 102 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the system 102 can perform a set of machine-learning computations. For instance, the system 102 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

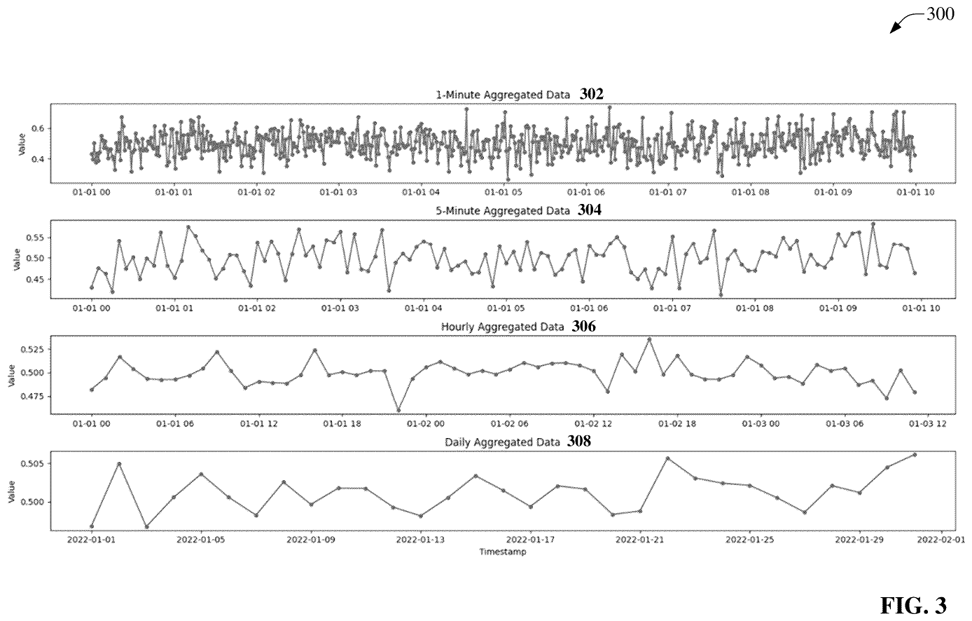

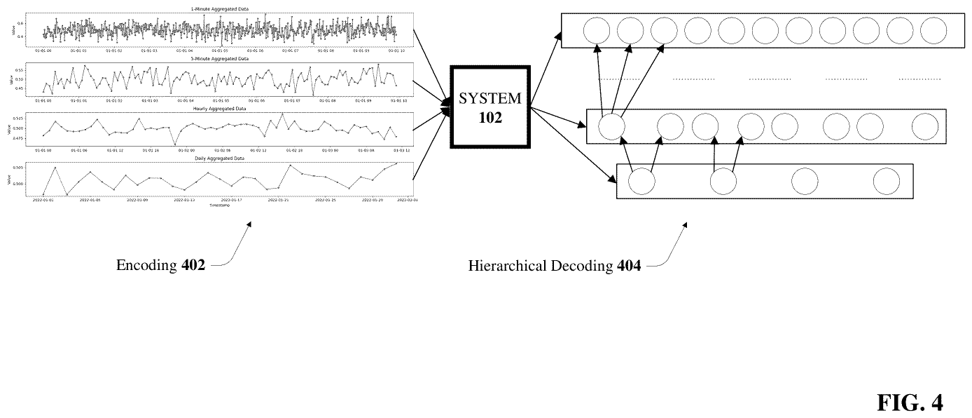

FIG. 3 is a diagram of sample data 300 (e.g., time series data) (e.g., performance data 112) at different frequencies (e.g., resolutions) in accordance with one or more example embodiments described herein. For instance, FIG. 3 depicts one-minute aggregated data 302, five-minute aggregated data 304, hourly aggregated data 306, and daily aggregated data 308. In this regard, the performance data 112 can comprise one or more of the one-minute aggregated data 302, five-minute aggregated data 304, hourly aggregated data 306, and/or daily aggregated data 308. FIG. 4 is diagram depicting autoencoding and hierarchical decoding (e.g., via the system 102) in accordance with one or more example embodiments described herein. In various example embodiments, the encoding 402 can comprise the sample data 300. The encoding 402 can be processed, by the system 102, in order to generate hierarchical decoding 404. The hierarchical decoding 404 can comprise decoded time series data (e.g., via the reconstruction component 202) at different time intervals (e.g., intervals corresponding to the encoding 402) along with determined (e.g., via the reconstruction component 202, for instance, using the performance data encoder-decoder model 114) relationships between the different intervals.

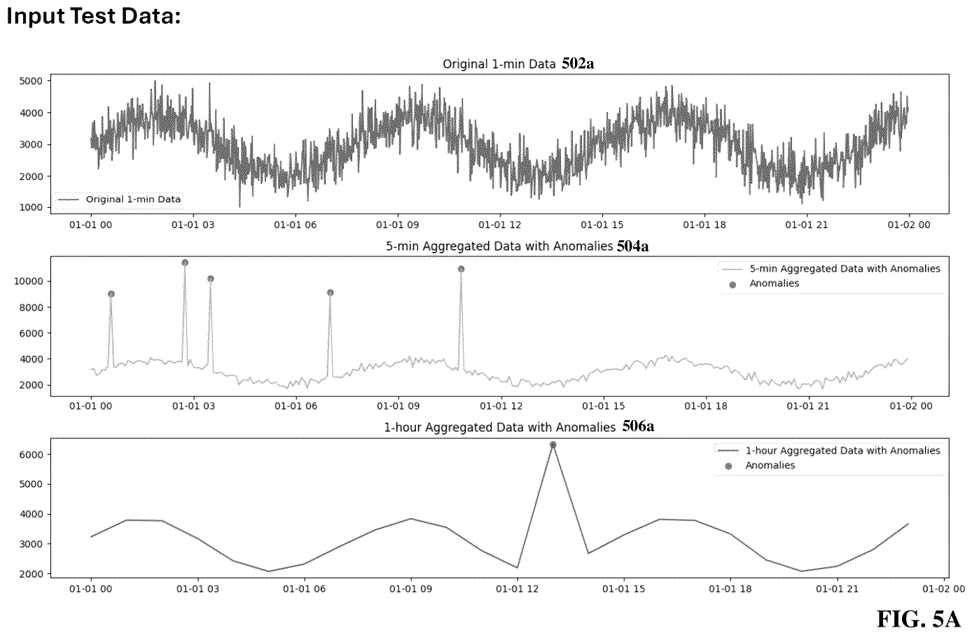

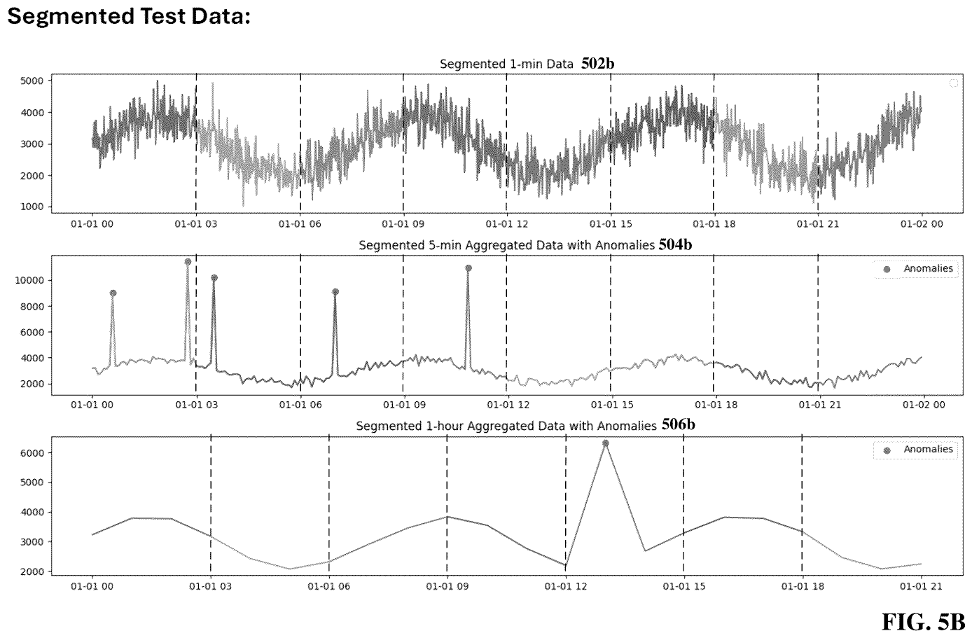

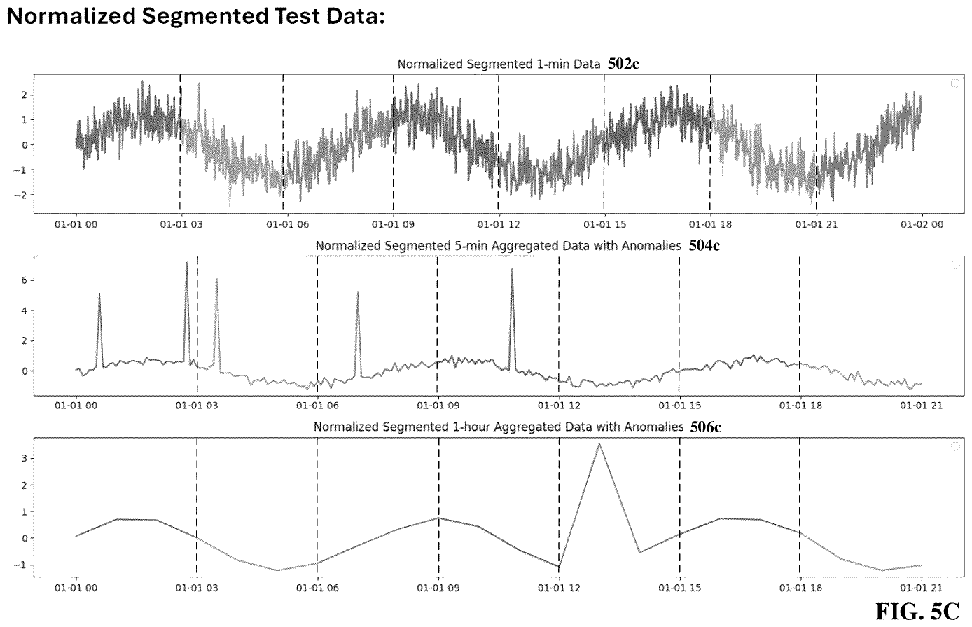

FIGS. 5A-5C are diagrams of example input test data, segmented test data, and normalized segmented test data in accordance with one or more example embodiments described herein. FIG. 5A depicts input test data, which can comprise one-minute data 502a, five-minute aggregated data with anomalies 504a, and one-hour aggregated data with anomalies 506a. In FIG. 5B, the input test data is segmented (e.g., via the system 102) into segmented test data. In this regard, the system 102 can segment one-minute data 502a into segmented one-minute data 502b, five-minute aggregated data with anomalies 504a into segmented five-minute aggregated data with anomalies 504b, and one-hour aggregated data with anomalies 506a into segmented one-hour aggregated data with anomalies 506b. It is noted that the system 102 can segment data herein into intervals common to the different time series data, as depicted in FIG. 5B. In FIG. 5C, the segmented test data can be normalized (e.g., via the system 102) into normalized segmented test data (normalized via the system 102 as previously discussed herein), resulting in normalized segmented one-minute data 502c, normalized segmented five-minute aggregated data with anomalies 504c, and normalized segmented one-hour aggregated data with anomalies 506c, for instance, using a defined time series data normalization process.

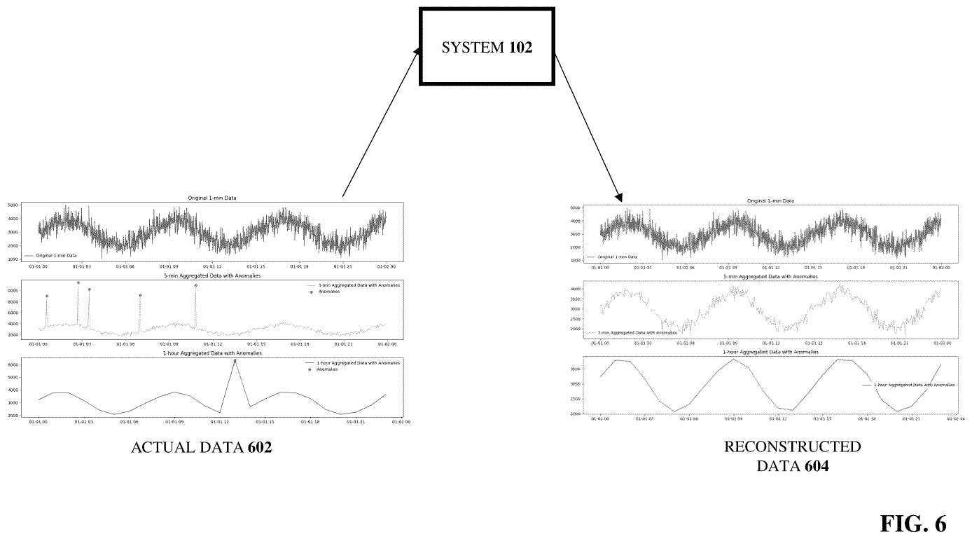

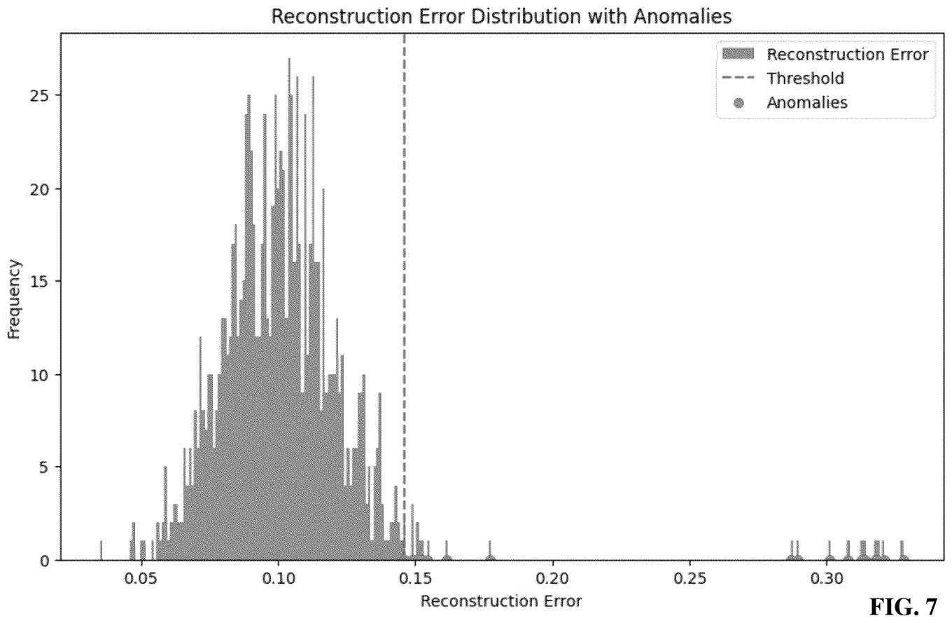

FIG. 6 is a diagram of example reconstruction in accordance with one or more example embodiments described herein. In FIG. 6, actual data 602 can be processed, by the system 102, in order to generate reconstructed data 604. For the reconstructed data 604, the system 102 can calculate reconstructed errors, for instance, based on MSE and/or DTW. In one or more example embodiments, the performance data encoder-decoder model 114 can be trained to minimize this error. In various example embodiments, Equation (1) can be utilized to minimize error. FIG. 7 is a chart of an example reconstruction error distribution with anomalies in accordance with one or more example embodiments described herein. As shown, reconstruction errors outside of the threshold (e.g., determined via the system herein as previously discussed) can be flagged (e.g., via the system 102) as anomalies.

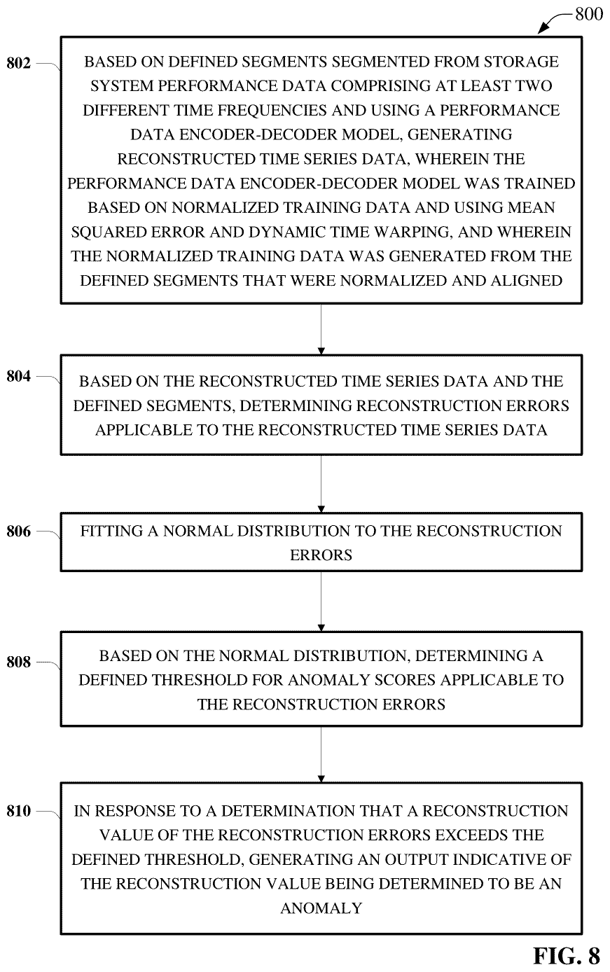

FIG. 8 illustrates a block flow diagram for a process 800 associated with performance anomaly detection in storage systems using autoencoder with hierarchical multi-frequency decoding in accordance with one or more embodiments described herein. At 802, the process 800 can comprise, based on defined segments segmented from storage system performance data (e.g., performance data 112) comprising at least two different time frequencies and using a performance data encoder-decoder model (performance data encoder-decoder model 114), generating (e.g., via the reconstruction component 202) reconstructed time series data, wherein the performance data encoder-decoder model was trained based on normalized training data and using mean squared error and dynamic time warping, and wherein the normalized training data was generated from the defined segments that were normalized and aligned. At 804, the process 800 can comprise, based on the reconstructed time series data and the defined segments, determining (e.g., via the error component 204) reconstruction errors applicable to the reconstructed time series data. At 806, the process 800 can comprise fitting (e.g., via the fitting component 206) a normal distribution to the reconstruction errors. At 808, the process 800 can comprise, based on the normal distribution, determining (e.g., via the threshold component 208) a defined threshold for anomaly scores applicable to the reconstruction errors. At 810, the process 800 can comprise, in response to a determination that a reconstruction value of the reconstruction errors exceeds the defined threshold, generating (e.g., via the communication component 210) an output indicative of the reconstruction value being determined to be an anomaly.

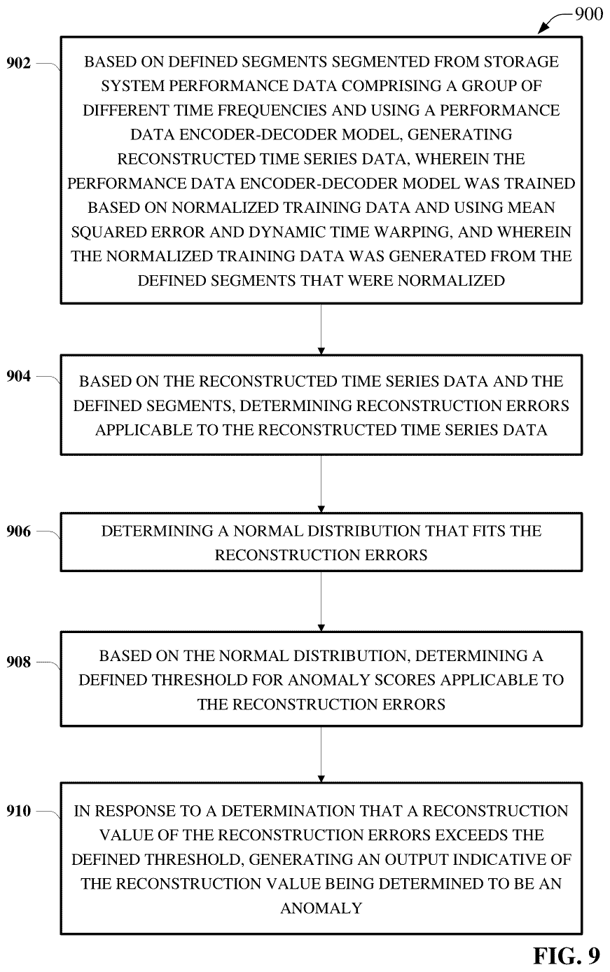

FIG. 9 illustrates a block flow diagram for a process 900 associated with performance anomaly detection in storage systems using autoencoder with hierarchical multi-frequency decoding in accordance with one or more embodiments described herein. At 902, the process 900 can comprise, based on defined segments segmented from storage system performance data (e.g., performance data 112) comprising a group of different time frequencies and using a performance data encoder-decoder model (e.g., performance data encoder-decoder model 114), generating (e.g., via the reconstruction component 202) reconstructed time series data, wherein the performance data encoder-decoder model was trained based on normalized training data and using mean squared error and dynamic time warping, and wherein the normalized training data was generated from the defined segments that were normalized. At 904, the process 900 can comprise, based on the reconstructed time series data and the defined segments, determining (e.g., via the error component 204) reconstruction errors applicable to the reconstructed time series data. At 906, the process 900 can comprise determining (e.g., via the fitting component 206) a normal distribution that fits the reconstruction errors. At 908, the process 900 can comprise, based on the normal distribution, determining (e.g., via the threshold component 208) a defined threshold for anomaly scores applicable to the reconstruction errors. At 910, the process 900 can comprise, in response to a determination that a reconstruction value of the reconstruction errors exceeds the defined threshold, generating (e.g., via the communication component 210) an output indicative of the reconstruction value being determined to be an anomaly.

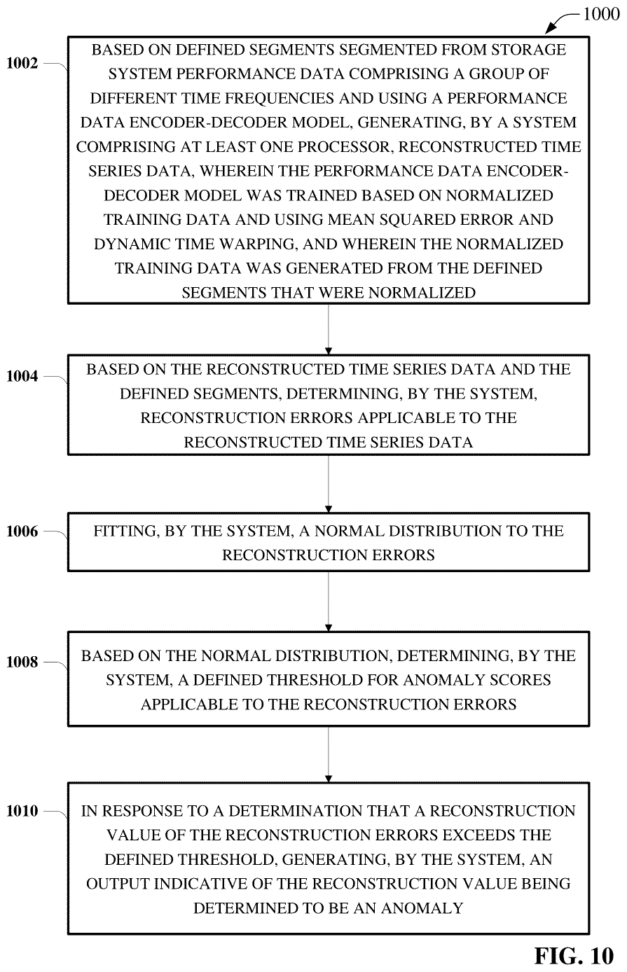

FIG. 10 illustrates a block flow diagram for a process 1000 associated with performance anomaly detection in storage systems using autoencoder with hierarchical multi-frequency decoding in accordance with one or more embodiments described herein. At 1002, the process 1000 can comprise, based on defined segments segmented from storage system performance data (e.g., performance data 112) comprising a group of different time frequencies and using a performance data encoder-decoder model (e.g., performance data encoder-decoder model 114), generating (e.g., via the reconstruction component 202), by a system (e.g., system 102) comprising at least one processor (e.g., processor 106), reconstructed time series data, wherein the performance data encoder-decoder model was trained based on normalized training data and using mean squared error and dynamic time warping, and wherein the normalized training data was generated from the defined segments that were normalized. At 1004, the process 1000 can comprise, based on the reconstructed time series data and the defined segments, determining (e.g., via the error component), by the system (e.g., system 102), reconstruction errors applicable to the reconstructed time series data. At 1006, the process 1000 can comprise fitting (e.g., via the fitting component 206), by the system (e.g., system 102), a normal distribution to the reconstruction errors. At 1008, the process 1000 can comprise, based on the normal distribution, determining (e.g., via the threshold component 208), by the system (e.g., system 102), a defined threshold for anomaly scores applicable to the reconstruction errors. At 1010, the process 1000 can comprise, in response to a determination that a reconstruction value of the reconstruction errors exceeds the defined threshold, generating (e.g., via the communication component 210), by the system (e.g., system 102), an output indicative of the reconstruction value being determined to be an anomaly.

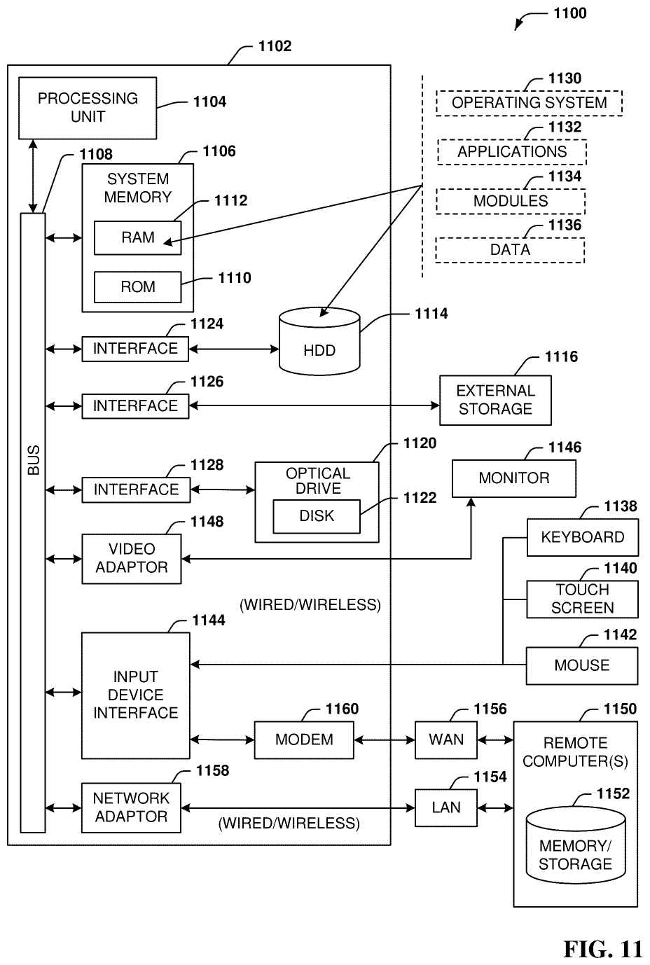

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared, and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a disk 1122, such as a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid-state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or another type of display device can also be connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

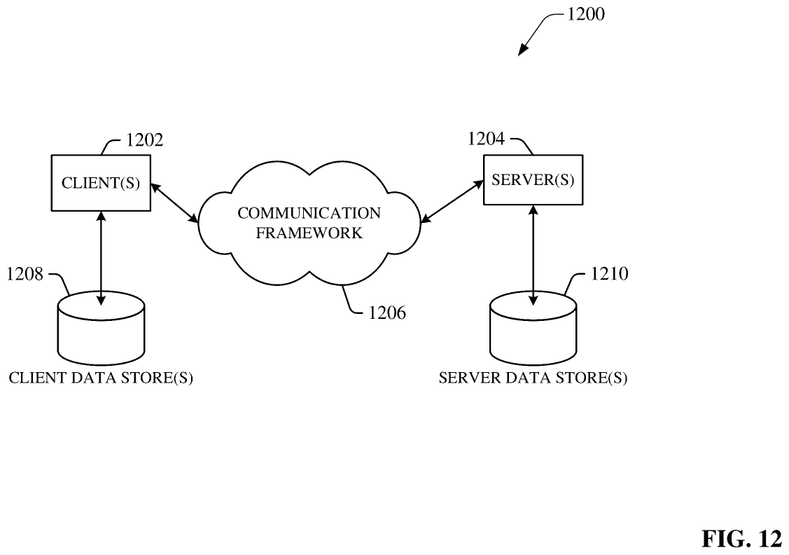

Referring now to FIG. 12, there is illustrated a schematic block diagram of a computing environment 1200 in accordance with this specification. The system 1200 includes one or more client(s) 1202, (e.g., computers, smart phones, tablets, cameras, PDA's). The client(s) 1202 can be hardware and/or software (e.g., threads, processes, computing devices). The client(s) 1202 can house cookie(s) and/or associated contextual information by employing the specification, for example.

The system 1200 also includes one or more server(s) 1204. The server(s) 1204 can also be hardware or hardware in combination with software (e.g., threads, processes, computing devices). The servers 1204 can house threads to perform transformations of media items by employing aspects of this disclosure, for example. One possible communication between a client 1202 and a server 1204 can be in the form of a data packet adapted to be transmitted between two or more computer processes wherein data packets may include coded analyzed headspaces and/or input. The data packet can include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

In one exemplary implementation, a client 1202 can transfer an encoded file, (e.g., encoded media item), to server 1204. Server 1204 can store the file, decode the file, or transmit the file to another client 1202. It is noted that a client 1202 can also transfer uncompressed files to a server 1204 and server 1204 can compress the file and/or transform the file in accordance with this disclosure. Likewise, server 1204 can encode information and transmit the information via communication framework 1206 to one or more clients 1202.

The illustrated aspects of the disclosure may also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A system, comprising:
at least one processor; and
at least one memory that stores executable instructions that, when executed by the at least one processor, facilitate performance of operations, comprising:
based on defined segments segmented from storage system performance data comprising at least two different time frequencies and using a performance data encoder-decoder model, generating reconstructed time series data, wherein generating the reconstructed time series data comprises generating the reconstructed time series data using a defined hierarchical decoding process that reconstructs the storage system performance data at multiple frequency resolutions, wherein the reconstructed time series data comprises a combined output of the multiple frequency resolutions, wherein the performance data encoder-decoder model was trained based on normalized training data and using mean squared error and dynamic time warping, and wherein the normalized training data was generated from the defined segments that were normalized and aligned;
based on the reconstructed time series data and the defined segments, determining reconstruction errors applicable to the reconstructed time series data;
fitting a normal distribution to the reconstruction errors;
based on the normal distribution, determining a defined threshold for anomaly scores applicable to the reconstruction errors; and
in response to a determination that a reconstruction value of the reconstruction errors exceeds the defined threshold, generating an output indicative of the reconstruction value being determined to be an anomaly.

2. (canceled)

3. The system of claim 1, wherein the operations further comprise:
based on a quantity of frequencies of the at least two different time frequencies, determining a quantity of encoding layers for use with the performance data encoder-decoder model.

4. The system of claim 1, wherein the operations further comprise:
determining a confidence level applicable to the reconstruction errors, wherein the defined threshold is further determined based on the confidence level.

5. The system of claim 1, wherein the storage system performance data comprises at least one of a latency, a bandwidth, or a file size applicable to a storage system.

6. The system of claim 1, wherein the performance data encoder-decoder model comprises a long short-term memory model.

7. The system of claim 1, wherein the operations further comprise:
in response to determining the reconstruction errors, deleting the storage system performance data.

8. The system of claim 1, wherein the normalized and aligned defined segments were generated based on duplicates of first data points of first defined segments of the defined segments, and wherein, as a result of the duplicates being generated, first data points of the first defined segments are equal in quantity to second data points of second defined segments of the defined segments.

9. The system of claim 1, wherein the performance data encoder-decoder model was trained based on weights determined to be applicable to training of the performance data encoder-decoder model.

10. The system of claim 1, wherein the storage system performance data comprises at least one of one-minute aggregated time series data aggregated every minute, five-minute aggregated time series data aggregated every five minutes, hourly aggregated time series data aggregated every hour, or daily aggregated time series data aggregated every day.

11. The system of claim 1, wherein the storage system performance data is representative of performance data of a defined group of devices.

12. The system of claim 1, wherein the reconstructed time series data comprises an aggregate of the at least two different time frequencies.

13. A non-transitory machine-readable medium, comprising executable instructions that, when executed by at least one processor, facilitate performance of operations, comprising:
based on defined segments segmented from storage system performance data comprising a group of different time frequencies and using a performance data encoder-decoder model, generating reconstructed time series data, wherein generating the reconstructed time series data comprises generating the reconstructed time series data using a defined hierarchical decoding process that reconstructs the storage system performance data at multiple frequency resolutions, wherein the reconstructed time series data comprises a combined output of the multiple frequency resolutions, wherein the performance data encoder-decoder model was trained based on normalized training data and using mean squared error and dynamic time warping, and wherein the normalized training data was generated from the defined segments that were normalized;
based on the reconstructed time series data and the defined segments, determining reconstruction errors applicable to the reconstructed time series data;
determining a normal distribution that fits the reconstruction errors;
based on the normal distribution, determining a defined threshold for anomaly scores applicable to the reconstruction errors; and
in response to a determination that a reconstruction value of the reconstruction errors exceeds the defined threshold, generating an output indicative of the reconstruction value being determined to be an anomaly.

14. (canceled)

15. The non-transitory machine-readable medium of claim 13, wherein the operations further comprise:
based on a quantity of frequencies of the group of different time frequencies, determining a quantity of encoding layers to be utilized with the performance data encoder-decoder model.

16. The non-transitory machine-readable medium of claim 13, wherein the operations further comprise:
determining a confidence level applicable to the reconstruction errors, wherein the defined threshold is further determined based on the confidence level.

17. The non-transitory machine-readable medium of claim 13, wherein the storage system performance data comprises at least one of a latency, a bandwidth, or a file size applicable to a storage system.

18. A method, comprising:
based on defined segments segmented from storage system performance data comprising a group of different time frequencies and using a performance data encoder-decoder model, generating, by a system comprising at least one processor, reconstructed time series data, wherein generating the reconstructed time series data comprises generating the reconstructed time series data using a defined hierarchical decoding process that reconstructs the storage system performance data at multiple frequency resolutions, wherein the reconstructed time series data comprises a combined output of the multiple frequency resolutions, wherein the performance data encoder-decoder model was trained based on normalized training data and using mean squared error and dynamic time warping, and wherein the normalized training data was generated from the defined segments that were normalized;
based on the reconstructed time series data and the defined segments, determining, by the system, reconstruction errors applicable to the reconstructed time series data;
fitting, by the system, a normal distribution to the reconstruction errors;
based on the normal distribution, determining, by the system, a defined threshold for anomaly scores applicable to the reconstruction errors; and
in response to a determination that a reconstruction value of the reconstruction errors exceeds the defined threshold, generating, by the system, an output indicative of the reconstruction value being determined to be an anomaly.

19. The method of claim 18, further comprising:
in response to determining the reconstruction errors, removing, by the system, the storage system performance data.

20. The method of claim 18, wherein the reconstructed time series data comprises an aggregate of the group of different time frequencies.

21. The method of claim 18, wherein the storage system performance data comprises at least one of a latency, a bandwidth, or a file size applicable to a storage system.

22. The method of claim 18, further comprising:
based on a quantity of frequencies of the group of different time frequencies, determining, by the system, a quantity of encoding layers for use with the performance data encoder-decoder model.
